(19) United States
(12) Patent Application Publication
(10) Pub. No.: US 2026/0252510 A1
(43) Pub. Date: Aug. 27, 2026

(54) COLLECTING AND TRANSMITTING DATA AT AN INFORMATION HANDLING SYSTEM

(71) Applicant: Dell Products L.P., Round Rock, TX (US)

(72) Inventors: Ibrahim Sayyed, Georgetown, TX (US); Srivatsa Venkataramiah Seshachalam, Bengaluru (IN); Cheng Chien Hsu, Taipei City (TW); Alan Helmy Abdelhalim, Pflugerville, TX (US)

(21) Appl. No.: 19/060,409

(22) Filed: Feb. 21, 2025

(51) Int. Cl. G06F 13/36

(52) U.S. Cl. CPC G06F 13/36; G06F 2213/40

(57) ABSTRACT

Transmitting telemetry data from an information handling system, including obtaining telemetry data of one or more computing components of the information handling system; storing the telemetry data in a host physical memory of the information handling system; accessing memory of an embedded controller (EC) of the information handling system; transferring the telemetry data from the host physical memory to the memory of the EC; and transferring the telemetry data from the memory of the EC to a backend computing device over an out-of-band (OOB) communication channel.

### BACKGROUND

### Field of the Disclosure

The disclosure relates generally to an information handling system, and in particular, collecting and transmitting telemetry data at the information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Telemetry data collection involves gathering real-time data from remote or inaccessible sources for monitoring and analysis. This data is used for understanding system performance, detecting anomalies, and making informed decisions. Various industries, including telecommunications, healthcare, and automotive, rely on telemetry to ensure their systems and devices operate efficiently and effectively.

### SUMMARY

Innovative aspects of the subject matter described in this specification may be embodied in a method of transmitting telemetry data from an information handling system, including obtaining telemetry data of one or more computing components of the information handling system; storing the telemetry data in a host physical memory of the information handling system; accessing memory of an embedded controller (EC) of the information handling system; transferring the telemetry data from the host physical memory to the memory of the EC; and transferring the telemetry data from the memory of the EC to a backend computing device over an out-of-band (OOB) communication channel.

Other embodiments of these aspects include corresponding systems, apparatus, and computer programs, configured to perform the actions of the methods, encoded on computer storage devices.

These and other embodiments may each optionally include one or more of the following features. For instance, storing the telemetry data in virtual memory of the information handling system after obtaining the telemetry data; and copying the telemetry data from the virtual memory to the host physical memory. Transferring the telemetry data from the host physical memory to the memory of the EC by an enhanced serial peripheral interface (eSPI) controller. The eSPI controller copies the telemetry data from the host physical memory to the memory of the EC. Transferring the telemetry data from the memory of the EC to the backend computing device over the OOB communication channel using a wireless wide area network (WWAN) embedded subscriber identity module (eSIM). The WWAN eSIM is only in communication with the EC at the information handling system. The WWAN eSIM is not visible to an operating system (OS) of the information handling system. The information handling system is not connected to the Internet via Wi-Fi. Providing a signal to the EC to notify the EC of the telemetry data stored at the memory of the EC. Performing diagnostic analysis of the information handling system based on the telemetry data. Receiving, from the backend computing device, data indicating one or more adjustments to the one or more computing components based on the telemetry data; and adjusting parameters of the one or more computing components based on the received data.

Particular implementations of the subject matter described in this specification can be implemented so as to realize one or more of the following advantages. For example, the invention ensures critical telemetry is reliability transmitted to the backend (e.g., service provider), even if the device (information handling system) does not have Internet access via its primary means (e.g., Wi-Fi) for such issues as servicing and fraud detection.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for collecting and transmitting telemetry data.

FIG. 3 illustrates a method for collecting and transmitting telemetry data.

### DESCRIPTION OF PARTICULAR EMBODIMENT(S)

This disclosure discusses methods and systems for collecting and transmitting telemetry data of an information handling system. In short, the information handling system leverages an “out-of-band” method of telemetry transmission (e.g., to a backend computing device) where a limited set of critical telemetry data needs to be uploaded in a timely matter. The information handling system relies on a WWAN and/or eSIM 222 connected to an EC for remote manageability/administration, and for a communication path to send critical telemetry to the backend computing device.

Specifically, this disclosure discusses a system and a method for transmitting telemetry data from an information handling system, including obtaining telemetry data of one or more computing components of the information handling system; storing the telemetry data in a host physical memory of the information handling system; accessing memory of an embedded controller (EC) of the information handling system; transferring the telemetry data from the host physical memory to the memory of the EC; and transferring the telemetry data from the memory of the EC to a backend computing device over an out-of-band (OOB) communication channel.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

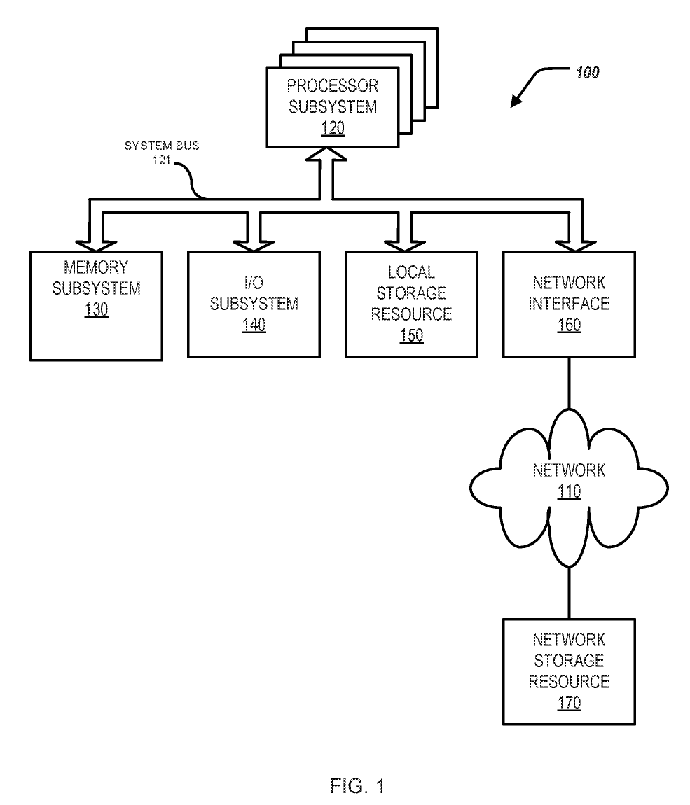

Particular embodiments are best understood by reference to FIGS. 1-3 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system 100). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

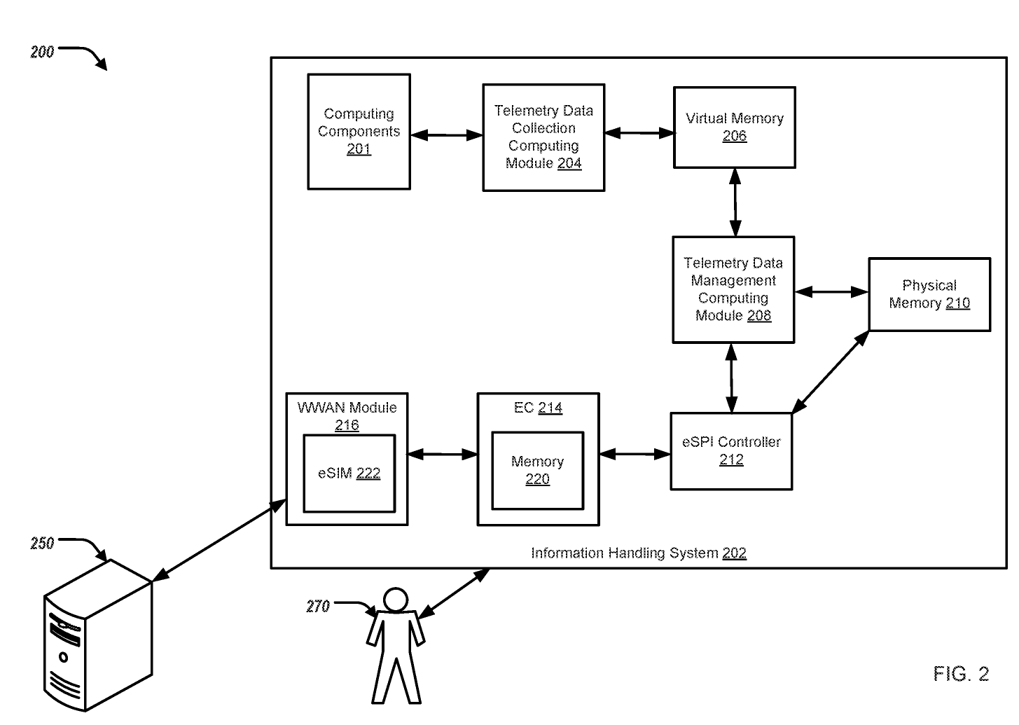

Turning to FIG. 2, FIG. 2 illustrates an environment 200 including an information handling system 202 and a backend computing device 250. The information handling system 202 can include computing components 201, a telemetry data collection computing module 204, virtual memory 206, telemetry data management computing module 208, physical memory 210, an enhanced serial peripheral interface (eSPI) controller 212, an embedded controller (EC) 214, and a wireless wide area network (WWAN) module 216. The EC 214 can include memory 220. The WWAN module 216 can include an embedded subscriber identity module (eSIM) 222. In some examples, the information handling system 202 is similar to, or includes, the information handling system 100 of FIG. 1.

The telemetry data collection computing module 204 can be in communication with the computing components 201 and the virtual memory 206. The telemetry data management computing module 208 can be in communication with the virtual memory 206, the physical memory 210, and the eSPI controller 212. The eSPI controller 212 can be in communication with the telemetry data management computing module 208, the physical memory 210, and the EC 214. The EC 214 can be in communication with the eSPI controller 212 and the WWAN module 216.

The computing components 201 can include one or more of a central processing unit (CPU), memory (such as DDR), disk drive (such as HDD or SDD), graphics processing unit (GPU), fan, battery, or any type of processing/computing element.

In some examples, the telemetry data management computing module 208 is an advanced configuration and power interface (ACPI) source language (ACL) / Kernal driver. In some examples, the memory 220 of the EC 214 can include up to 256 bytes per transaction. The eSPI controller 212 is an interface between the telemetry data management computing module 208 and the EC 214 where the eSPI controller 212 has the addressable memory range to the EC 214.

In short, the information handling system 202 leverages an “out-of-band” method of telemetry transmission (e.g., to the backend computing device 250) where a limited set of critical telemetry data needs to be uploaded in a timely matter. The information handling system 202 relies on the WWAN module 216 and/or the eSIM 222 connected to the EC 214 for remote manageability/administration, and for a communication path to send critical telemetry to the backend computing device 250.

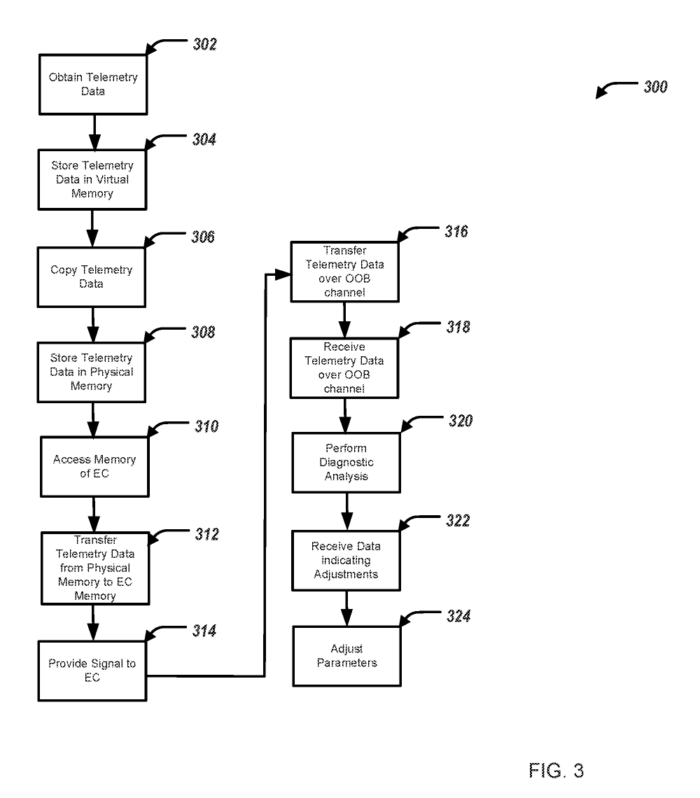

FIG. 3 illustrates a flowchart depicting selected elements of an embodiment of a method 300 for collecting and transmitting telemetry data. The method 300 may be performed by the information handling system 100, the information handling system 202, the telemetry data collection computing module 204, the telemetry data management computing mode 208, the eSPI controller 212, the EC 214, and/or the WWAN module 216, and with reference to FIGS. 1-2. It is noted that certain operations described in method 300 may be optional or may be rearranged in different embodiments.

The telemetry data collection computing module 204 can obtain telemetry data of the computing components 201, at 302. For example, the telemetry data can include a power type of the battery (AC or DC), health of the fan, power limits of the CPU, core temperature of the CPU, SMART data of the disk drive, GPU frequency levels, GPU load, and the like. The telemetry data collection computing module 204 can obtain the telemetry data of the computing components 201 periodically (e.g., every 1 millisecond, 1 second, 1 minute), or in response to a request.

The telemetry data collection computing module 204 can store the telemetry data in the virtual memory 206 after obtaining the telemetry data, at 304. The telemetry data management computing module 208 can copy the telemetry data form the virtual memory 206 to the host physical memory 210, at 306. For example, the telemetry data management computing module 208 can utilize a pointer from the virtual memory 206 indicating the position of the telemetry data to copy the telemetry data from the virtual memory 206 to the physical memory 210.

The telemetry data management computing module 208 can store the telemetry data in the physical memory 210, at 308. In some examples, copying the telemetry data from the virtual memory 206 to the physical memory 210 is the same as storing the telemetry data in the physical memory 210.

The eSPI controller 212 can access the memory 220 of the EC 214, at 310. For example, the telemetry data management computing module 208 can provide instructions to the eSPI controller 212 to access the physical memory 210.

The eSPI controller 212 transfers the telemetry data from the physical memory 210 to the memory 220 of the EC 214, at 312. Specifically, the telemetry data management computing module 208 accesses the physical memory 210 through the eSPI controller 212 and identifies the memory location of the telemetry data to copy the telemetry data to the physical memory 210.

The eSPI controller 212 provides a signal to the EC 214 to notify the EC of the telemetry data stored at the memory 220, at 314. That is the telemetry data management computing module 208, through the eSPI controller 212, provides a signal to the EC 214 (“rings doorbell”) to notify the EC 214 of the telemetry data stored at the memory 220. Specifically, the signal can be provided through a general-purpose input/output (GPIO) pin of the EC 214.

The WWAN module 216 transfers the telemetry data from the memory 220 of the EC 214 to the backend computing device 250 over an out-of-band (OOB) communication channel, at 316. Specifically, the EC 214 communicates directly with the WWAN module 216 to transmit the data to the backend computing device 250. In some examples, the EC 214 transfer the telemetry data from the memory 220 to the backend computing device 250 over the OOB communication channel using the eSIM 222. In some examples, the eSIM 222 is only in communication with the EC 214. In some examples, the eSIM 222 is not visible to an operating system (OS) or a basic input/output system (BIOS) of the information handling system 202. That is, the OS and/or the BIOS is unaware of (has no knowledge of) the eSIM 222. That is, the eSIM is independent of the OS and/or the BIOS of the information handling system 202. The WWAN module 216 and/or the eSIM 222 is not accessible by the OS and/or the BIOS of the information handling system 202. In some examples, the information handling system 202 is not connected to the Internet via Wi-Fi.

The backend computing device 250 can receive the telemetry data, at 318. The backend computing device 250 can perform diagnostic analysis of the information handling system 202 based on the telemetry data, at 320. In some examples, the backend computing device 250 can calculate one or more adjustments to one or more parameters of one or more of the computing components 201 based on the received telemetry data. The adjustments can include increases and/or decreases to the power limits of the CPU, the core temperature of the CPU, GPU frequency levels, GPU load, and the like. The adjustments can include adjustments to the power type of the battery and the like. The backend computing device 250 can perform the diagnostic analysis based on a predetermined model, algorithm, and/or machine-learning processing.

The backend computing device 250 can transmit the data indicating the one or more adjustments to the one or more parameters of the one or more computing components 201 to the information handling system 202. The information handling system 202 receives the adjustment data, at 322. In some examples, the WWAN module 216 via the eSIM 222 can receive the adjustment data. In some examples, when the information handling system 202 is connected to Wi-Fi (at a later time), the information handling system 202 can receive the adjustment data via Wi-Fi.

The information handling system 202 adjusts the one or more parameters of the one or more computing components 201 based on the received adjustment data, at 324. For example, the information handling system 202 can increase and/or decrease the power limits of the CPU, the core temperature of the CPU, the GPU frequency levels, the GPU load, and the like. For example, the information handling system 202 can adjust the power type of the battery and the like.

In some further implementations, the BIOS and/or OS can have a selectable option to enable/disable telemetry data transmission via the WWAN module 216. For example, the selectable option can be a graphical user interface (GUI) element that the user 270 can enable/disable by user input via a user input element such as a keyboard, mouse, touchscreen, and the like. In some examples, the GUI element is only presented when presence of the user 270 is detected. For example, the information handling system 202 can include a user detection apparatus, and only upon detection of the user 270 does the information handling system 202 provide the GUI element that the user can enable/disable for telemetry data transmission via the WWAN module 216.

In a use case example, the user 270 brings the information handling system 202 (laptop) to a location with no Wi-Fi connection (e.g., by default). The information handling system 202 (laptop) has recently auto-healed memory issues (computing components 201) and telemetry data needs to be transmitted to the backend computing device 250 for diagnostics. The information handling system 202 can implement the method 300 described herein for such, utilizing the WWAN module 216 and the eSIM 222.

In a use case example, the user 270 is traveling and drops (fall event) the information handling system 202 (laptop). The information handling system 202 (laptop) needs to transmit telemetry data to the backend computing device 250 regarding the fall event, but there is no nearby Wi-Fi networks. The information handling system 202 can implement the method 300 described herein for such, utilizing the WWAN module 216 and the eSIM 222.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of transmitting telemetry data from an information handling system, comprising:
obtaining telemetry data of one or more computing components of the information handling system;
storing the telemetry data in a host physical memory of the information handling system;
accessing memory of an embedded controller (EC) of the information handling system;
transferring the telemetry data from the host physical memory to the memory of the EC; and
transferring the telemetry data from the memory of the EC to a backend computing device over an out-of-band (OOB) communication channel.

2. The computer-implemented method of claim 1, further including:
storing the telemetry data in virtual memory of the information handling system after obtaining the telemetry data; and
copying the telemetry data from the virtual memory to the host physical memory.

3. The computer-implemented method of claim 1, further including transferring the telemetry data from the host physical memory to the memory of the EC by an enhanced serial peripheral interface (eSPI) controller.

4. The computer-implemented method of claim 3, wherein the eSPI controller copies the telemetry data from the host physical memory to the memory of the EC.

5. The computer-implemented method of claim 1, further including:
transferring the telemetry data from the memory of the EC to the backend computing device over the OOB communication channel using a wireless wide area network (WWAN) embedded subscriber identity module (eSIM).

6. The computer-implemented method of claim 5, wherein the WWAN eSIM is only in communication with the EC at the information handling system.

7. The computer-implemented method of claim 5, wherein the WWAN eSIM is not visible to an operating system (OS) of the information handling system.

8. The computer-implemented method of claim 1, wherein the information handling system is not connected to the Internet via Wi-Fi.

9. The computer-implemented method of claim 1, further including:
providing a signal to the EC to notify the EC of the telemetry data stored at the memory of the EC.

10. The computer-implemented method of claim 1, further including:
performing diagnostic analysis of the information handling system based on the telemetry data.

11. The computer-implemented method of claim 10, further including:
receiving, from the backend computing device, data indicating one or more adjustments to the one or more computing components based on the telemetry data; and
adjusting parameters of the one or more computing components based on the received data.

12. An information handling system comprising a processor having access to memory media storing instructions executable by the processor to perform operations, comprising:
obtaining telemetry data of one or more computing components of the information handling system;
storing the telemetry data in a host physical memory of the information handling system;
accessing memory of an embedded controller (EC) of the information handling system;
transferring the telemetry data from the host physical memory to the memory of the EC; and
transferring the telemetry data from the memory of the EC to a backend computing device over an out-of-band (OOB) communication channel.

13. The information handling system of claim 12, the operations further including:
storing the telemetry data in virtual memory of the information handling system after obtaining the telemetry data; and
copying the telemetry data from the virtual memory to the host physical memory.

14. The information handling system of claim 12, the operations further including transferring the telemetry data from the host physical memory to the memory of the EC by an enhanced serial peripheral interface (eSPI) controller.

15. The information handling system of claim 14, wherein the eSPI controller copies the telemetry data from the host physical memory to the memory of the EC.

16. The information handling system of claim 12, the operations further including:
transferring the telemetry data from the memory of the EC to the backend computing device over the OOB communication channel using a wireless wide area network (WWAN) embedded subscriber identity module (eSIM).

17. The information handling system of claim 16, wherein the WWAN eSIM is only in communication with the EC at the information handling system.

18. The information handling system of claim 16, wherein the WWAN eSIM is not visible to an operating system (OS) of the information handling system.

19. The information handling system of claim 12, wherein the information handling system is not connected to the Internet via Wi-Fi.

20. A non-transitory computer-readable medium storing software comprising instructions executable by one or more computers which, upon such execution, cause the one or more computers to perform operations comprising:
obtaining telemetry data of one or more computing components of the information handling system;
storing the telemetry data in a host physical memory of the information handling system;
accessing memory of an embedded controller (EC) of the information handling system;
transferring the telemetry data from the host physical memory to the memory of the EC; and
transferring the telemetry data from the memory of the EC to a backend computing device over an out-of-band (OOB) communication channel.
